(19) United States
(12) Patent Application Publication
(10) Pub. No.: US 2021/0289812 A1
(43) Pub. Date: Sep. 23, 2021

(54) TEXTURE MODIFIED FOOD PRODUCT

(71) Applicant: I Cook Catering Services Pty Ltd, Dandenong South, Victoria (AU)

(72) Inventors: Ian William Cook, Cleveland, Queensland (AU); Michael Andrew Cook, Blackburn, Victoria (AU)

(21) Appl. No.: 17/059,908

(22) PCT Filed: May 23, 2019
(86) PCT No.: PCT/AU2019/050507

§ 371 Date: Nov. 30, 2020

(30) Foreign Application Priority Data
Jun. 1, 2018 (AU) 2018203879

(51) Int. Cl. A23J 3/22; A23L 29/212; A23L 29/269; A23L 33/22; A23P 30/10; A23L 5/20; A23L 3/02

(52) U.S. Cl. CPC A23J 3/225; A23L 29/212; A23L 29/27; A23L 3/02; A23P 30/10; A23L 5/276; A23L 33/22

(57) ABSTRACT

The invention is directed broadly to a method of preparing a texture modified food product for consumption by a dysphagic consumer, comprising the steps: (a) providing a cooked fish or meat; (b) comminuting the cooked fish or meat to form a paste; and (c) forming the paste into the texture modified food product shaped and textured to a generic serve of the fish or meat selected to form the paste.

### TECHNICAL FIELD

The invention relates to the field of texture modified foods, also referred to as puree foods. Specifically, the invention relates to a method of preparing a selected meat or fish and also to a texture modified meat or fish product formed to resemble a serving of the selected meat or fish. The invention also relates to a method of forming and packaging the texture modified meat or fish product.

### BACKGROUND

For many people, whether through age, dental condition, illness or accident, the act of swallowing becomes laboured, painful or even impossible. The loss of the ability to swallow is given the medical name dysphagia and refers to the specific medical condition where the passage of solids or liquids from the mouth to the stomach becomes difficult.

The effects of dysphagia can be physical, where the dysphagic individual is susceptible to pulmonary aspiration and possible aspiration pneumonia brought about by food going into the lungs and not into the oesophagus. In some cases, this condition can be managed with texture modified foods “tmf”. However, there is a delicate balance to be found between puree foods which are not so runny as to leak into the larynx and trachea but conversely not so solid to require chewing or manipulation and not sticky so as to become adhered to the palate. This balance is further complicated when foods are susceptible to heat, as the heat of the mouth can rapidly decrease the viscosity of certain foods.

Often overlooked is the psychological effect of dysphagia. A dysphagic individual may be nutritionally stable on a tmf diet but no longer feels comfortable to eat in front of others. Furthermore, a tmf option is seldom available at restaurants, such that a dysphagic individual cannot elect to eat at a restaurant with friends and family and thus become isolated from many of the social aspects of dining.

Typically, tmf is prepared as a puree by boiling or steaming a protein, such as meat or fish until it is fully cooked and very soft, so that it can be blended with sufficient liquid (stock or cooking water), to form a smooth paste. The blended puree is then thickened with any starch, commonly mashed potato, tapioca starch or maize starch. The finished puree is then plated in measured dome-shaped scoops. Made in this traditional manner, the product lacks aesthetic appeal due to the monochrome colour of the puree which is typically faded and pale as a result of the heating and blending processes. The puree is also of poor nutrient density, which happens because of the dilution effect of adding the stock or cooking water required to achieve the puree end product. Diluting and then thickening a protein to form a puree in this manner will also bind the fats of the product into the puree thereby losing the appearance of meat.

The present invention was conceived with these shortcomings in mind.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

### SUMMARY OF THE INVENTION

The invention provides a method of preparing a texture modified food product for consumption by a dysphagic consumer, comprising the steps: (a) providing a cooked meat or fish; (b) comminuting the cooked meat or fish to form a paste; and (c) forming the paste into the texture modified food product shaped and textured as a generic serving of the meat or fish selected to form the paste.

In some embodiments, the paste may be formed in a mould. The mould may be configured to mould the paste into a “fish-shape” portion. In some embodiments the meat or fish paste may be moulded to closely resemble the selected meat or fish. The paste may be moulded to resemble, by way of example only, a fish fillet, a prawn, a scallop, a slice of meat, a breast of chicken, a rasher of bacon, a pork chop, a strip steak, a sausage or a burger etc, promoting the illusion that the finished texture modified food product is a serving of a non-texture modified food.

The method described herein achieves a realistic looking finished product as the selected protein is not diluted. Furthermore, by comminuting the protein while it is still hot, the natural collagens and gelatins in the protein will add to the texture of the paste. Selecting cuts of meat with a high content of connective tissue will further add nutrient density to the finished product as well as improving the appearance. When the moulded texture modified product 1 is pasteurised some fats can be released from the finished product, which is a speckled appearance to the surface, similar to a natural meat portion.

In the step of providing cooked meat or fish, the cooked meat or fish may be cooked until just cooked. In other embodiments, the cooking process may be extended to assist in breaking down the proteins within the meat or fish to facilitate achieving the desired texture to the paste. The temperature and duration of the cooking process may depend on the particular meat or fish to be cooked, to ensure that the cooking process has sufficiently killed bacteria on the raw protein and achieved desired tenderness.

The term “cooked” is understood herein in reference the US Food and Drug Administration (FDA) Time-Temperature “Kill Step” Graph which defines that a product reaches a core temperature of above 55 degrees Celsius and holds this temperature for a corresponding period of time to achieve a cooked status.

The term “fish” as referred to herein is understood to include fish and seafood for human consumption eg. prawns, scallops, mussels, calamari, lobster, eel, tuna, salmon, flake, cod, plaice, and mullet and the like.

The step of comminuting the cooked meat or fish may comprise chopping the cooked meat or fish (as herein defined).

The method may further comprise the step of assessing the consistency of the paste. Where necessary, the consistency of the paste may be adjusted. In the case of shellfish, the method may further comprise the step of adding oil, butter or cream to prevent the proteins reconnecting to form a solid.

The step of moulding the paste to form the texture modified food product may comprise setting the paste in a mould.

The method facilitates the production of realistic food portion sizes that further reflect a realistic looking meat or fish portion. The method provides texture modified food products that closely resemble a serving of the original meat or fish in form, exterior texture, taste and nutritional content. The texture modified food products provided promote the appetite of the consumer and reinstate a modicum of normalcy and dignity to meal times and dining occasions.

The step (b) may include comminuting the cooked fish or meat without any added water or liquid stock. The process does not rely on diluting the natural meat or fish products with broths and stocks that can result in the dilution of nutrients in the end product and damage to the flavour profile of the finished product.

The step of cooking the raw meat or fish may involve plunging the meat or fish into boiling water for a predetermined time period. The raw meat or fish may be heated and cooked by other means, for example, roasting, microwaving, steaming, grilling or any other wet method of cooking done in a food grade plastic bag so as to retain flavour and nutrients to list but a few options.

The step of chopping the cooked meat or fish may be performed with a shear-blade cutter or a bowl cutter. This step is preferably conducted while the meat or fish is still hot, although the meat or fish may be cooled and subsequently reheated before chopping, due to operational factors.

The step of chopping the cooked meat or fish may additionally comprise the step of aerating and chopping the cooked meat or fish until the paste takes on a mousse-like consistency. The step of adjusting the mixture may involve repeating or extending the duration of the chopping step.

The term “chopped” as used herein is intended to describe broadly the process of physically breaking down the cooked meat or fish into small enough pieces to form a paste, as such chopping includes, cutting, slicing, milling, grinding and dicing etc. The particles can range anywhere in size from 5-40 microns, and the exact particle size of the chopped meat or fish will vary for different raw proteins.

The step of assessing the consistency of the paste additionally may involve adjusting the mixture to increase the viscosity of the paste to meet a predetermined standard.

The method may further comprise the step of introducing an additive into the mixture prior to setting the paste in the mould. The additive may be selected from at least one of: Xanthan gum; modified potato starch; agglomerated modified potato starch (AMPS); natural vegetable fibre; bamboo fibre; flavourless starch; maize starch; salt and pepper.

The ability to hold shape and texture of the final texture modified food product is advantageous through the (i) transportation, (ii) unpackaging, (iii) plating and (iv) heating processes. If any of these processes (i)-(iv) result in excessive damage to the shape and texture of the product when plated before the consumer, the resemblance to non-textured food could be lost or diminished along with the appeal, and opportunity to positively affect the consumer's appetite.

The method may comprise the step of introducing the paste into the mould while warm, prior to setting the paste in the mould. The method may comprise the step of introducing the paste into the mould while cold, prior to setting the paste in the mould.

The method may further comprise the step of integrating the mould with a thermoforming machine.

The method may maintain the mould at a temperature below 1 degree Celsius to set the texture modified food product.

The mould may provide a recess shaped and/or textured to a generic serving form of the raw meat or fish selected to form the paste. The mould may provide a plurality of recesses shaped and/or textured to the generic serving form of the raw meat or fish selected to make the paste. Each of the plurality of shaped recesses may have an equal volume.

The method may further comprise the step of lining the mould with a first layer of packaging material prior to introducing the paste therein.

The mould may be configured as a die. The die may provide at least one venting hole therein, to draw air from the recesses shape into the die. The die may be connectable with a vacuum forming machine or with a thermo-forming machine. In some embodiments the paste is moulded using a vacuum moulding or by blow moulding machine. A greater degree of detail can be achieved in the moulded product if a plug assisted method is employed with the vacuum forming process.

The method may include the step of vacuum assisting the drawing of the first layer of packaging material into the mould prior to receiving the paste.

The venting holes in the die require redesign and modification to support the drawing of the lining material into complex curves and recesses of a realistic mould shape. This requires detailed analysis of the form to be created and significant work to achieve an even draw across the surface of the mould.

The method may further comprise the step of operatively engaging the mould with a thermo-forming machine. The method may further comprise the step of disposing a second layer of packaging material over the mould after the paste has been received therein and fusing the second layer with the first layer of packaging material thereby forming a sealed pouch around the moulded texture modified food product.

The texture modified food products can be formed in individual portions in full three-dimensional forms or in flat-bottom shapes, that are easily retained on a plate and cannot roll about.

The lining material protects the moulded texture modified food product thereby reducing contamination risk. The lining material also increases production rates achievable from a single set of moulds.

Without the lining, each filling, freezing and releasing of the mould would require a full clean, sterilisation and drying step before another batch of the product could be formed. The sterilisation step would be further complicated with the plurality of air vents running from the mould into the die.

The die of the present invention is lined with a sterile film to form a new mould each time before receiving the paste which is formed and frozen, then released for the next batch to begin. The finished texture modified food product is instantly sealed into the packaging reducing additional handling steps thereby reducing contamination risk. The next time the product is contacted is when it is released from the package ready for imminent consumption.

The method may further comprise the step of air evacuating the sealed pouch prior to sealing. This can reduce the possibility of freezer burn on the finished texture modified food products. This step provides advantages in increasing the shelf-life of the finished product.

The method may further comprise the step of back-flushing the pouch with carbon dioxide and nitrogen to remove suspended oxygen from the moulded texture modified food product prior to sealing the pouch.

The method may further comprise the step of hot pasteurising the sealed pouch to increase usable shelf life of the packaged product. The method may further comprise the step of cold pasteurising the sealed pouch to increase usable shelf life of the packaged product.

The method may further comprise the step of freezing the sealed pouch for distribution.

In a second aspect, the invention provides a texture modified food product made by the method described herein.

In one aspect, the invention provides a texture modified food product for consumption by a dysphagic consumer, comprising; a paste formed from a meat or fish, the paste retaining the colour, nutritional content and the taste of the selected meat or fish; and an additive selected from a group comprising: Xanthan gum; Guar gum; modified potato starch; agglomerated modified potato starch (AMPS); natural vegetable fibre; bamboo fibre; flavourless starch; salt and pepper, wherein the texture modified food product is shaped and textured to a generic serving of the meat or fish selected to form the paste.

The paste may be made from any one of the following: bacon, beef, calamari, chicken, duck, eel, flake, ham, lamb, lobster, mullet, mussels, plaice, pork, prawns, salmon, scallops, tuna, turkey, veal, venison, egg, horse meat, snails and any other protein consumed by people regardless of cultural preference.

The above list of meats and fish are merely examples and most meats and fish can be processed in the above described manner. This provides the ability to present a restaurant quality meal in terms of presentation and flavour that promotes social inclusion.

The texture modified food product may be adjusted in portion size to suit a consumer's appetite.

The texture modified food product may be pre-planned and plated, prior to heating for consumption.

The texture modified food product may be plated frozen.

The texture modified food product may retain its shape through a thawing or heating process.

The texture modified food product may be reheated during a meal without loss of shape or colour.

A plurality of texture modified food products made from different meat and fish products may be combined on a plate with texture modified vegetable products to present the consumer with a full texture modified meal. The individual texture modified food products on the plate may remain separate. The separation of individual texture modified products on a plate may be maintained through a thawing process. The separation of individual texture modified products on a plate may be maintained through a heating process.

Individual texture modified food products are produced to a single taste profile. However, the individual components can then be plated to form a meal, a casserole or a stir fry, that brings these individual elements together but still provides for individual consumption. A consumer can eat servings of mashed potato, beef and vegetable products at their leisure and not be forced to confront or consume all meal components blended together in single serving or discoloured pulp.

The single prepared servings of each product provide ultimate flexibility on portion size and nutritional content of a given meal, to comply with recommended serving sizes from a dietitian. As the texture modified food products do not require any cutting or additional processing there is little waste and a consistent presentation of the food products.

Various features, aspects, and advantages of the invention will become more apparent from the following description of embodiments of the invention, along with the accompanying drawings in which like numerals represent like components.

### BRIEF DESCRIPTION OF THE DRAWINGS

Embodiments of the invention are illustrated by way of example, and not by way of limitation, with reference to the accompanying drawings, of which:

FIG. 1 is a perspective view of a texture modified food product, the product is made from chicken and configured to closely resemble a chicken breast according to an embodiment of the invention; FIG. 2 is a perspective view of a texture modified food product in the form of a 3-dimensional prawn;

FIG. 2A is a perspective view of a portion of texture modified beef product in the form of three slices of cooked meat, illustrating a flesh-like texture to the surface of the product;

FIG. 2B is a perspective view of a texture modified food product in the form of a 3-dimensional chicken drumstick, illustrating a mould separation line, where two flat-bottom texture modified chicken pieces have been formed into a 3-dimensional drumstick form;

FIG. 3 is a perspective view of a meal combining a plurality of texture modified food products, each product formed from either a vegetable or a protein, to form a casserole meal;

FIG. 4 is a perspective view of a meal combining a plurality of texture modified food products where texture modified protein product is combined with a plurality of texture modified vegetable products which have been cut and sliced to form a stir-fry meal;

FIG. 5a is a perspective view of a meal combining a plurality of texture modified vegetable products with a texture modified chicken product and a texture modified potato product, to form a roast chicken meal;

FIG. 5b is a perspective view of a meal combining a plurality of texture modified vegetable products with the texture modified beef product from FIG. 2A and a texture modified potato product, to form a roast beef meal;

FIG. 6A is a perspective view of a die for forming two three-dimensional, flat bottomed protein products formed to resemble chicken drumsticks;

FIG. 6B is a top view of a die having a single moulding recess for forming three-dimensional, flat bottomed texture modified beef product to resemble three meat slices, illustrating a plurality of air passages extending from the moulding recess into the body of the die;

FIG. 7 is an end view of a packaged, three-dimensional protein product;

FIG. 8 is a perspective view of the packaged product of FIG. 7, which can be frozen and stored before being removed from the package and heated for consumption;

FIG. 9 is a perspective view of a die for forming a plurality of flat bottomed protein products simultaneously, in the form of drumsticks;

FIG. 10 is a schematic view of a texture modified paste being distributed into a moulding recess of FIG. 9, illustrating two layers of packaging material: a first inside the moulding recess and a second laid across the moulding recess, prior to thermoforming the finished texture modified food product;

FIG. 11 is an end view of a thermoformed package of a texture modified protein product having a flat-bottom;

FIG. 12A is a perspective view of a multi-pack of the texture modified fish or meat product, illustrating perforation lines within the package;

FIG. 12B is a perspective view of a packaged texture modified beef product in a sliced form;

FIG. 13A is a perspective view of a die for forming a texture modified food product, illustrating an air vent extending through a base of the die into a moulding recess on a top surface of the die, to assist in the forming process;

FIG. 13B is a sectional view through the moulding recess of the die in FIG. 13, illustrating a primary air passage in the base of the die and a plurality of vacuum passages in fluid communication with the primary air passage and a surface of the moulding recess;

FIG. 14 is a perspective view of an alternative mould for forming a texture modified chicken product, illustrating a plurality of supplementary air passages through the mould to tailor the thermoforming process to more complicated mould forms;

FIG. 15 is a flow chart of a method for forming a texture modified food product from a fish or meat source FIG. 16 is a perspective view of a meal combining a plurality of texture modified vegetable products with a texture modified protein product and a texture modified potato product, illustrating a coating applied to the potato product to resemble a fried potato chip;

FIG. 17 is a perspective view of a meal combining a coated texture modified potato product with a coated texture modified fish product, to form a meal of fish and chips; and

FIG. 18 is a perspective view of a meal combining a coated, glazed texture modified chicken product and a texture modified vegetable product coated with a fermented vegetable coating to form Kim Chi.

Embodiments will now be described more fully hereinafter with reference to the accompanying drawings, in which various embodiments, although not the only possible embodiments, of the invention are shown. The invention may be embodied in many different forms and should not be construed as being limited to the embodiments described below.

### DETAILED DESCRIPTION OF EMBODIMENTS

The texture modified food product described and illustrated herein is primarily in relation to meat, this is merely illustrative, and it is contemplated that the texture modified food product and method of preparation described herein is generally applicable to all manner of consumable protein sources, from meats, fish and other seafood. Some steps of the process are adjustable to cater for specific meats or fish which may require more rigorous processing due to their cellular structure, for example beef, or less rigorous processing, for example salmon.

The term “food” as used herein is understood to refer generally to all meats and fish for human consumption. As such, the terms meat and fish are broadly used to refer to proteins from living organisms whether from land animals or aquatic animals that are safe for human consumption.

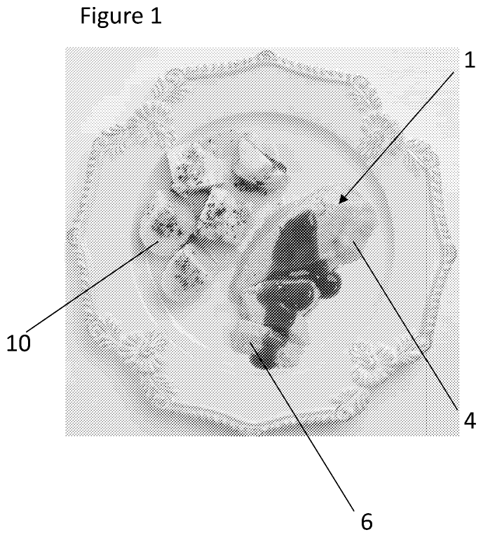

With reference to FIGS. 1-6, there is provided a food product 1, comprising; a paste 32 formed from a meat or fish, the paste 32 retaining the colour and the taste of the selected meat or fish; and an additive selected from a group comprising: Xanthan gum; modified potato starch; agglomerated modified potato starch (AMPS); Guar gum; natural vegetable fibre; bamboo fibre; flavourless starch; salt and pepper, wherein the food product 1 is shaped and textured to a generic serving of the meat or fish selected to form the paste 32.

With reference to FIG. 1, there is illustrated a chicken breast 6, comprising; a paste 32 formed from chicken, the paste 32 retaining the colour and the taste of chicken; and an additive selected from a group comprising: Xanthan gum; modified potato starch; agglomerated modified potato starch (AMPS); Guar gum; natural vegetable fibre; bamboo fibre; flavourless starch; salt and pepper, wherein the paste 32 is shaped and textured to resemble a chicken breast 6.

It is contemplated that alternative agglomerated modified starches could be added to the food product 1. For example, agglomerated tapioca; arrow root; grain; quinoa; corn; chickpea; spelt; and chia, starch.

In some embodiment, the fat or skin from the fish or meat is cooked and added to the paste which can improve the texture and mouthfeel of the finished texture modified food product and nutrient density.

Due to the food preparation techniques described herein, and the flavour retained in the finished texture modified food, salt and pepper and similar seasonings are not required. However, some fish and meat products can be flavour enhanced with salt and pepper, for example chicken.

The paste 32 can be made from any one of the following: bacon, beef, calamari, chicken, duck, eel, flake, ham, lamb, lobster, mullet, mussels, plaice, pork, prawns, salmon, scallops, tuna, turkey, veal, venison, egg, horse meat, snails and any other protein consumed by people regardless of cultural preference. It is further contemplated that combinations of the above meat and fish can be used to form a mixed paste, if desired.

The internal texture of the fish or meat product 1 is akin to a puree, in that a consumer will not need to chew the food product to break it down for swallowing. Conversely, the food product has a consistency that can hold the shape and texture of the desired food product 1 during and after being heated whether in a conventional oven, microwave, steamer or water bath.

The external texture of the food product 1 is formed from a moulding recess 22 of a die 20 in which the product 1 is moulded. An internal surface 28 of the mould can be stippled or textured 4 to resemble animal flesh across a surface of a breast of chicken 6 or slice of beef 13 or beef steak 15, or scales of a fish or shell of a crab of the texture modified food product 1.

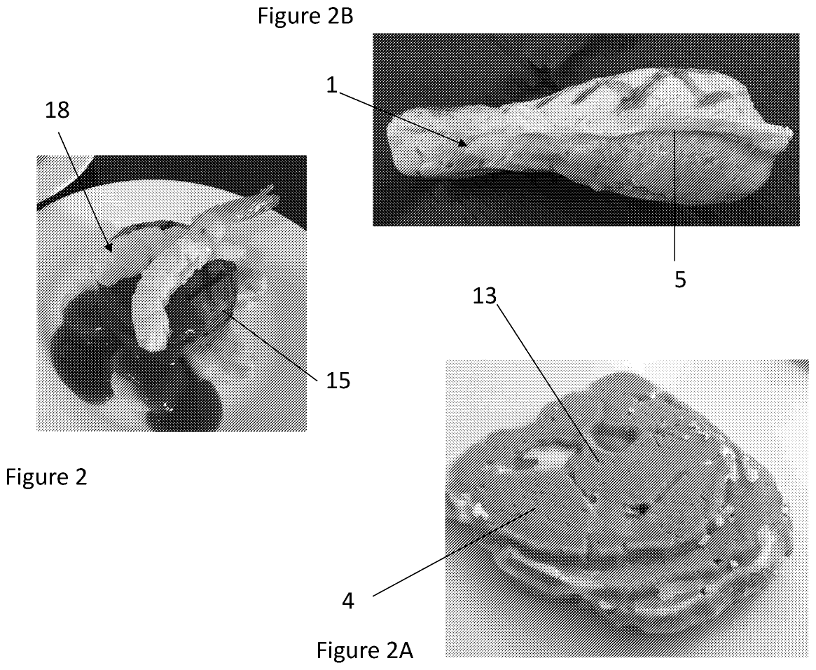

Additionally, a second internal surface 31 of the mould can be textured with a secondary texture to provide striations or a threaded formation to resemble skin of the texture modified food product 1 or an outer surface finish to a slice of texture modified meat product 6, illustrated in FIG. 2A, or the prawn of FIG. 2.

For some moulds, the texture on the mould surface can be shaped to resemble a bone-like form, particularly for darker meats, so that fat will settle into these contours and add to the realistic aesthetic of the texture modified product 1, while adding nutrient density.

For some texture modified products, it is contemplated that a meat bone can be roasted for colour and sterilised and then placed into the mould or formed into two pieces of the texture modified food product 1, to introduce the bone into the finished product 1. This is not intended for consumption but to further improve the authenticity and visual appearance of the meal and to extend the belief that the meal is not constituted from entirely texture modified food products. A similar effect is illustrated in FIG. 2, where the tail of a prawn has been sterilised and mounted to the texture modified prawn 18, served on a texture modified beef steak 15. The bone may be introduced at serving time or prior to the freezing of the product 1. Products that this technique could be applied to include: chicken drumsticks, rib eye steak; lamb chops; lamb rack; pork loin; baby back ribs, for example.

A single moulding recess 22 can be used to form the texture food product 1, which gives the food product 1 a flat-bottom. This can assist in keeping the food product 1 on a plate and prevents the product 1 from rolling around. For some consumers, this can be advantageous. As the product 1 can be formed with a flat-bottom, an alternative presentation of the product 1 involves joining the flat-bottoms of two products to form a single rounded, 3D food product, as illustrated by the chicken drumstick product of FIG. 2B, which illustrates a seam 5 showing where the two flat-bottomed products 1 have been joined together. In a still further embodiment, 3-dimensional dies/moulds can be manufactured to allow 3D, non-symmetrical food products to be formed.

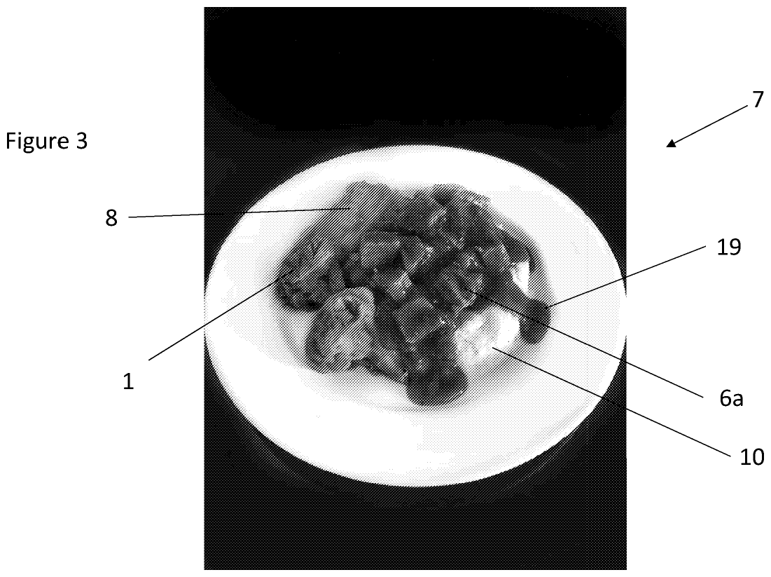

The texture modified food product 1 in some embodiments, is configured to resemble a whole product, for example a prawn or a scallop. In some embodiments, the food product 1 is configured to resemble a portion of the meat of fish, for example cubes of chicken 6a, a strip of chicken 6b, or a breast of chicken 6, as illustrated in FIGS. 3, 4 and 5.

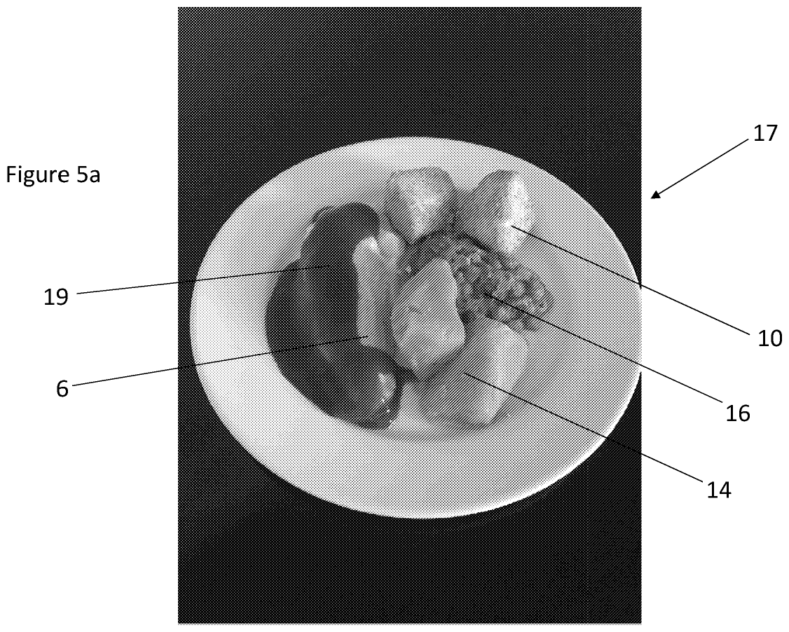

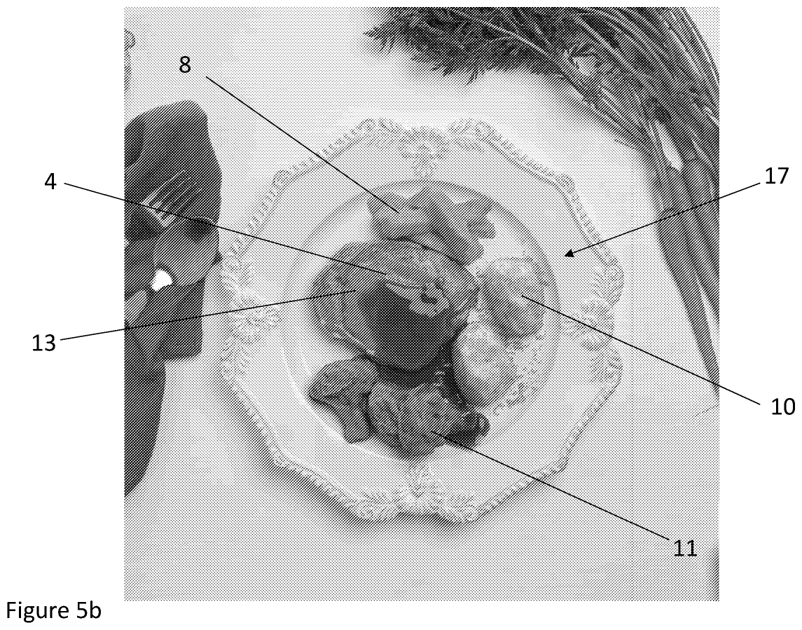

In other embodiments, the texture modified meat or fish product 1 is plated with a serving of texture modified vegetable products, for example a serve of peas 16, carrots 8 or a serve of beans as illustrated in FIGS. 3 and 5. The meat or fish product 1 is typically configured to resemble a cooked or prepared form of the selected meat or fish as illustrated in FIG. 5a with a chicken breast 6 accompanied with texture modified pumpkin 14, or in FIG. 5b illustrating slices of roast beef 13. This is to be contrasted to the texture modified vegetable products, which may be configured to resemble whole vegetables, for example a boiled potato 10 or floret of broccoli 11.

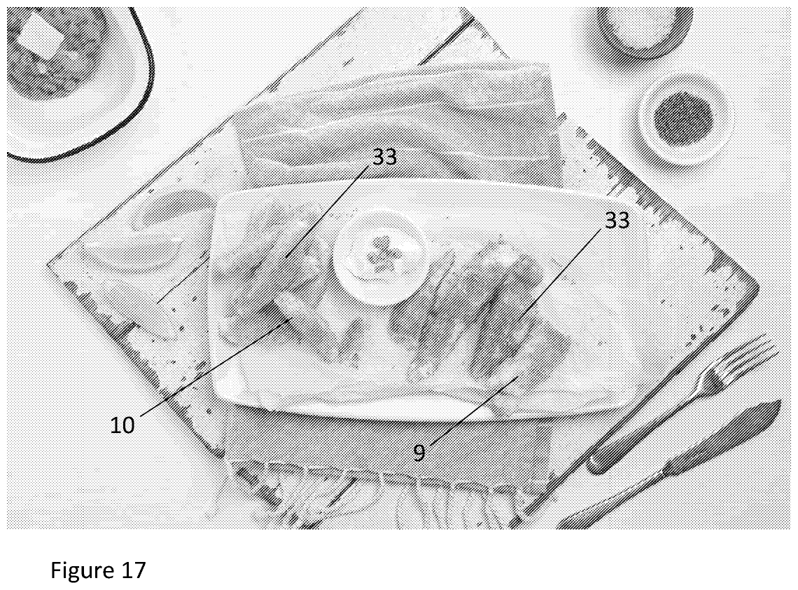

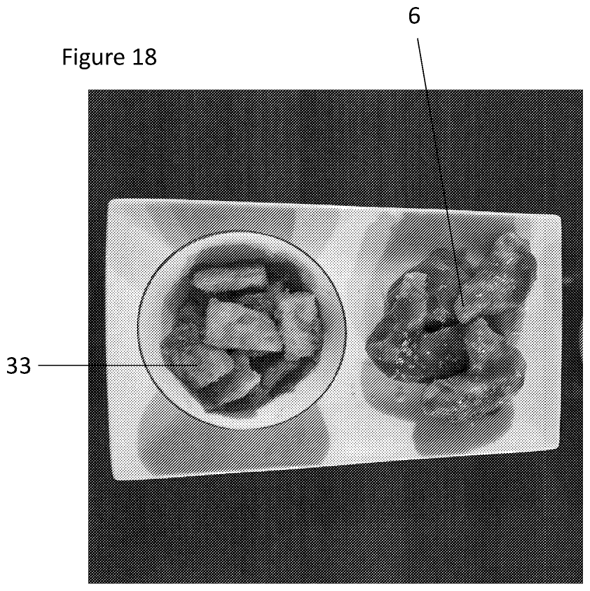

In another embodiment, illustrated in FIG. 17 a meal is formed from combining a coated texture modified potato product 10 with a coated texture modified fish product 9, to form a meal that looks, smells and tastes like fish and chips.

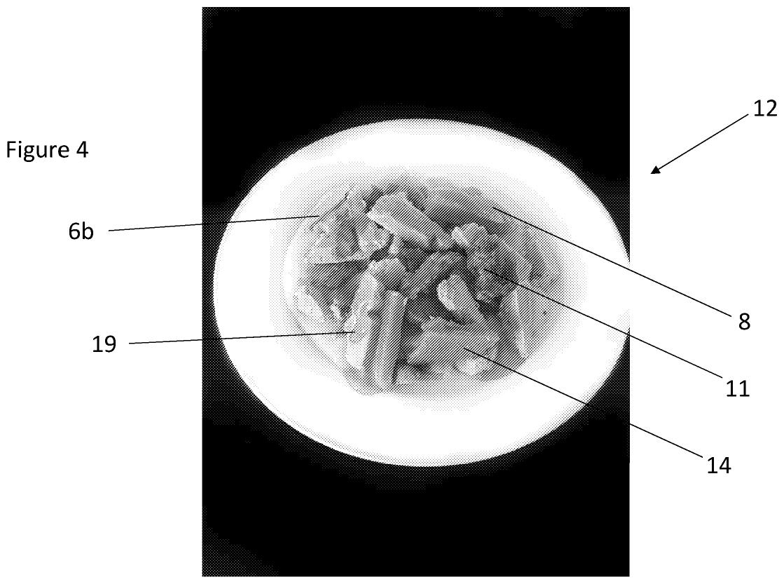

The mould can be designed such that, the finished food product 1 can embody subtle deformities or surface flaws and defects, that give the appearance of a cooked meat or fish, and not an overly idealised, “too perfect to be real” finish. In other embodiments, the texture modified food product 1 can be further divided or cut to give the appearance of a stir-fry dish 12, as illustrated in FIG. 4.

In each of the meals 7, 12 and 17 of FIGS. 3, 4, 5 and 5a, a gravy 19 or sauce has been added to the meal. The consistency of the gravy 19 is also required to conform to predetermined standards, as a runny gravy (low viscosity) will pose the same danger of entering the lungs as the texture modified food products that it is applied to for a dysphagic consumer.

The gravy 19 is not as viscous as the texture modified food product 1 and can be used to adjust the consistency of the texture modified food product 1, by the consumer, at the time of eating as it is not required by this invention to achieve the predetermined texture consistency standards. The gravy 19 can also compensate for any dehydration to the meat or fish product 1 where it has lost moisture during heating process. The addition of gravy 19 onto the texture modified product 1 also gives the visual effect of cooked meat distinguishing from typical puree meals.

An alternative sauce or sweet syrup can be used on some meat products to provide the benefits outlined above from a gravy 19, for example an apple sauce on a texture modified pork product or pineapple sauce on a texture modified ham product.

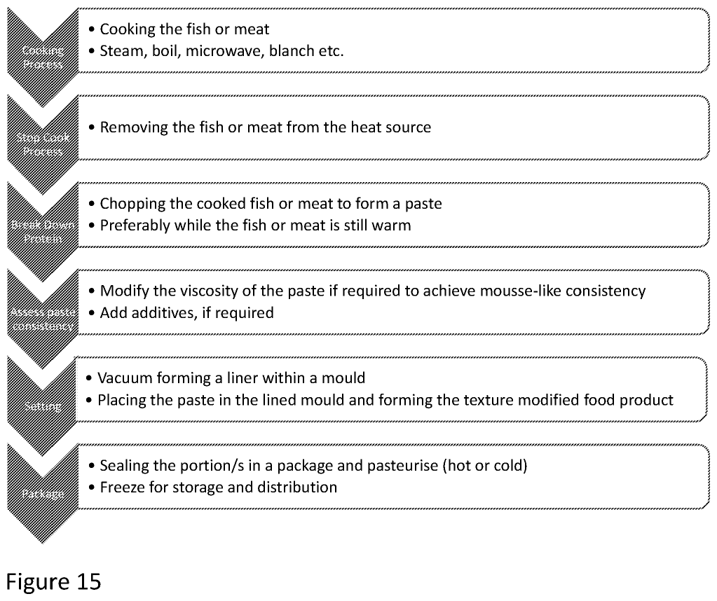

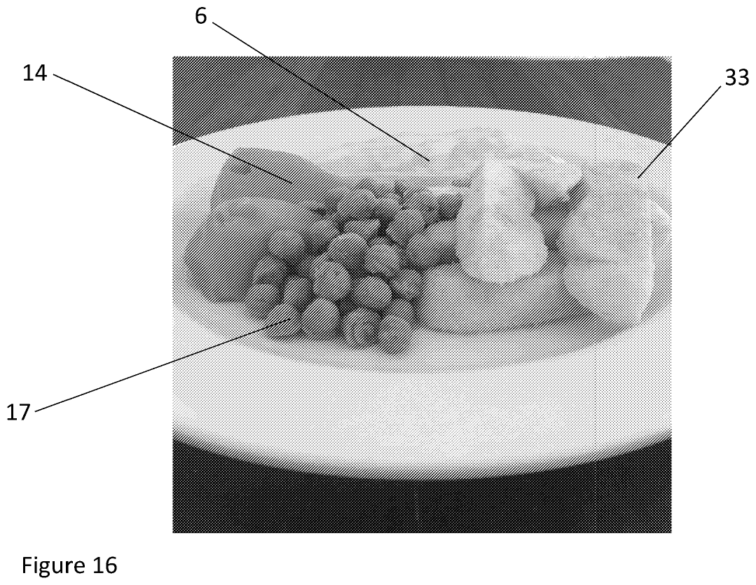

In one embodiment, illustrated in the flow process of FIG. 15, there is provided a method of preparing a food product 1, comprising the steps of:
a) providing cooked meat or fish;
b) comminuting or chopping the cooked meat or fish finely to form a paste 32;
c) assessing the consistency of the paste 32; and
d) forming the paste 32 in a mould 22 to shape and texture the food product to resemble a generic serving of the meat or fish selected to form the paste.

The cooking process is selected from one of the following cooking processes: boiling, steaming, baking, microwaving, braising, frying, grilling and roasting.

For some fish and meat, the protein can be vacuum sealed in an air-tight bag or jar and gently heated in a water bath, in a sous-vide style. Sous-vide is a much slower cooking technique than boiling or frying, where the cooking temperature is reduced to a minimum of 55° C., and maximum of boiling, and the cooking time extended accordingly with reference to the recommended guidelines eg. the FDA time-temperate graph which defines a relationship between cooking temperature and cooking time for different proteins, providing a gentler, and more even cooking of the protein.

For many people, their appetite is not merely stimulated by taste but by the visual appearance and smell of food. As such, for people with anorexia (or loss of appetite) the appearance and smell of a food is increasingly important to stimulate their appetite.

Cooking the protein in boiling water or any other cooking method provides for the removal of most aerobic microbial surface contaminants and bacteria from the surface of the protein. This is of great importance in view of the health and wellbeing of the intended consumer. This stage of the processing is sometimes referred to as a “kill step” as it is an important food hygiene step in the process.

Other methods of cooking the meat or fish until tender can be used, for example steaming, microwaving, or boiling to name but a few.

The cooked, meat or fish is then chopped to break down the flesh. As the protein needs to be finely chopped to attain the required consistency, a cutter or shear-blade is used. The blades need to be sharp to achieve the desired consistency of the protein and cleanly cut the meat or fish into minute pieces.

The cooking juices from the selected fish or meat can be added into the paste 32 to retain the nutrient density and palatability of the finished product 1. Alternatively, the cooking juices can be added to the cooked fish or meat prior to chopping, to combine these juices as the paste 32 is being formed.

The method can employ an industrial sesame mill or a large bowl cutter, with multiple chopping blades rotating at 3000-6000 rpm.

It is preferable to chop the cooked protein while hot, although these mills can be refrigerated to chop the product chilled. Where the chopping process is carried out quickly, the refrigerated mill is no longer necessary thus saving operating costs. Mills can also be referred to as emulsifiers as the product after milling can become emulsified.

When using the bowl cutter, a plurality of blades is used, axially arranged on a shaft to process the tender cooked meat or fish very quickly. Processing the meat or fish at high speed reduces the time available for bacteria to grow, therefore the increased processing rate of the bowl cutter is advantageous. The resulting paste 32 retains a greater nutrient density than a typical boiled/blended meat or fish puree.

As the meat or fish is chopped, the fast-moving blades of the bowl cutter add air to the paste, and thereby aerate the paste 32. As the meat or fish breaks down, there comes a point when the particle size of the chopped meat or fish is approximately equal to the size of the air bubbles introduced into the paste 32, and the paste can be seen to take on a mousse-like texture. Similar to whipping egg-whites, the paste 32 takes on a sheen and begins to form soft peaks. This an excellent indication that the particle size of the chopped meat or fish has been achieved and that the resulting paste 32 will not have a rough or grainy mouthfeel when consumed.

For many fish and meats, the change in texture for forming soft peaks can also be accompanied by a softening in colour to the trained eye, that is to say the colour of the paste 32 becomes a little paler as the mousse-like texture is achieved.

The chopping process in a bowl cutter can be extended in duration, until the physical appearance of the paste 32 starts to illustrate the desired mousse-like texture. Where a mill is used and the paste 32 has been milled and is not illustrating the mousse-like texture, the paste 32 can be re-passed through the mill to achieve the desired consistency.

The next stage of the process is to assess the consistency of the fish or meat paste 32 and for some proteins ie. fish, an additional step may be required to adjust the mixture to increase its flow characteristics to comply with a predetermined standard. To adjust the flow characteristic fibre is added and then the paste consistency is re-assessed. This can be conducted by testing whether the paste 32 can hold soft peaks. If required, more fibre is added until the desired consistency of the paste 32 is achieved. Starch can then be added to assist in achieving the desired final mousse-like texture.

### The International Dysphagia Diet Standardisation Initiative (IDDSI) Framework

While an international standardised system has not yet been established, a framework has been put in place to assess the consistency of both food and drink for those affected by dysphagia. The IDDSI uses specific terminology and definitions to describe texture modified foods and thickened liquids comprising 8 defined and colour coded levels (0-7). The studies conducted in putting together this framework found many factors that influence the flow behaviour and thus the rating of a food or a drink. These factors include: viscosity, density, yield stress, temperature, propulsion pressure, fat content and shear rate. In taking each of the above factors into consideration, the food and drink rating of 0-7 is derived from a gravity flow test. The test measures a retained volume of food or drink from a 10 mL sample left in a syringe after 10 seconds of flow. The categories rated 0-7 are illustrated in FIG. 16.

The IDDSI framework equates pureed food with an “extremely thick” liquid, which is defined as a liquid that sits on a spoon and does not flow off it. This is contrasted to a “moderately thick” liquid which would drip in dollops off the end of the spoon. The difficulty with a product that is too solid must be carefully balanced against the product being too viscous and flowing into the airways of the consumer, leading to additional medical complications.

Once the fish or meat paste 32 meets the required consistency, the paste 32 is introduced into the sterile lining material of the mould recess 22 of the die 20 to set the paste 32 into the finished serve of fish or meat shape. The introduction of the paste 32 into the recess 22 can be done when the paste is warm or cold, depending on the selected protein.

A fish or meat serving shaped recess 22 having a complex texture and/or fine detail can benefit from the paste being introduced into the die 20 while still warm, as this fills the recess 22 more completely.

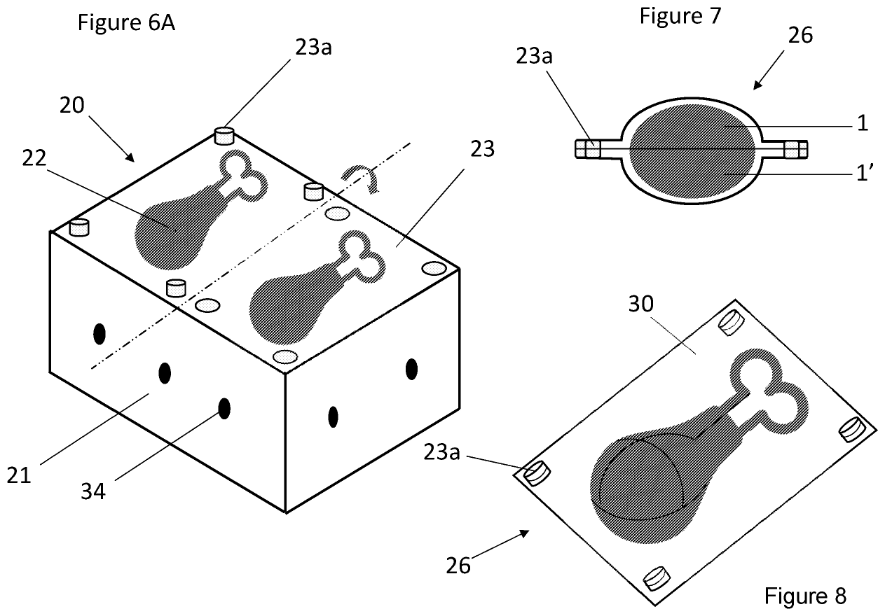

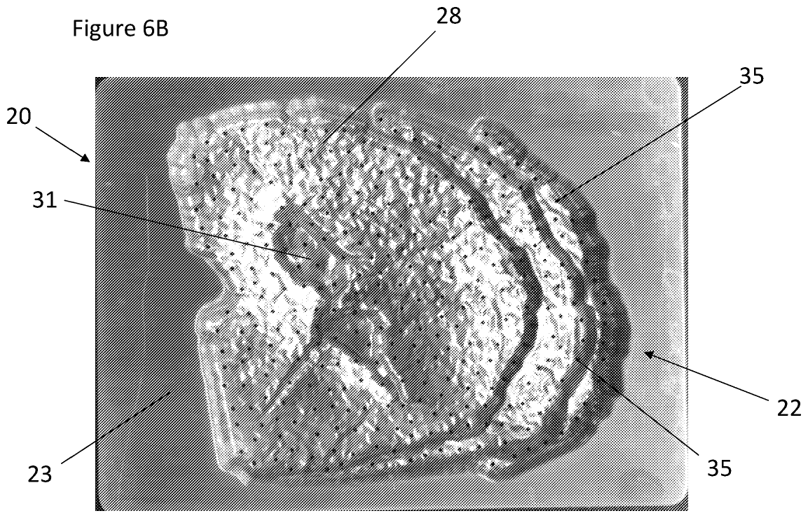

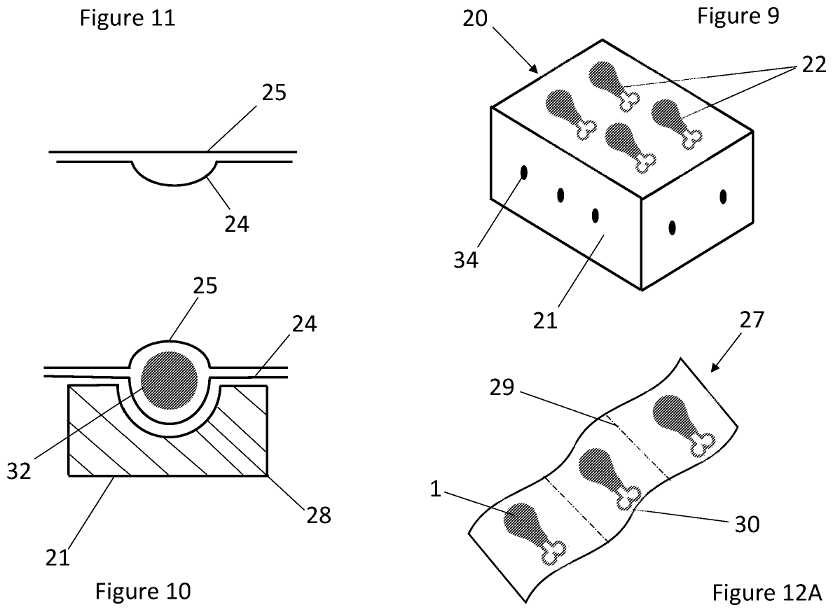

The die 20 is cut from an aluminium billet. The billet is machined to create a die base 21 and at least one moulding recess 22, illustrated in FIGS. 6A-6B. The moulding recess 22 can be CNC cut or laser cut and is shaped and textured to resemble a serving of a fish or meat. Accordingly, the details and form of the recess 22 can be taken from a 3D scan of a real piece of fish or fish portion or a piece of meat, as required. Alternative forms of moulding can be used to replicate more simplistic shapes. However, the 3D scanning techniques enable very complex mould forms to be created, increasing the illusion that the finished texture modified fish or meat product 1 is a non-texture modified fish or meat.

The recess 22 is formed into a top surface 23 of the die 20, and as such will produce a finished food product having a flat-base. Where a fully rounded food product 1 is desired, a pair of flat-based food products can be fused together, as illustrated with the protein product of FIG. 2B.

The top surface 23 of the die 20 can also provide tabs 23a or alternative cooperating protrusions and recesses to assist in the sealing and packaging of a finished food product 1, illustrated in FIGS. 7 and 8 as a single serve of product 1.

Effectively, the chicken drumstick, in FIG. 2B, constitutes a double portion of the finished texture modified food product. However, each individual fish or meat product constitutes a single-serve portion, typically between 100 g-120 g. When a consumer's needs have been assessed, a meal can be configured with the correct number of modified food products 1 to provide the required nutritional requirements.

Furthermore, the portion size in any given meal can be easily increased or decreased to account for fluctuations in the consumer's appetite. Traditional puree moulds do not provide this level of flexibility with no variation for small, medium and large portions. This can lead to waste of uneaten food and deterioration of the consumer's appetite, where the volume of food presented is off putting. Additionally, the texture modified food product can be off putting when an unrealistic or unnatural portion size is placed on a standard dinner plate.

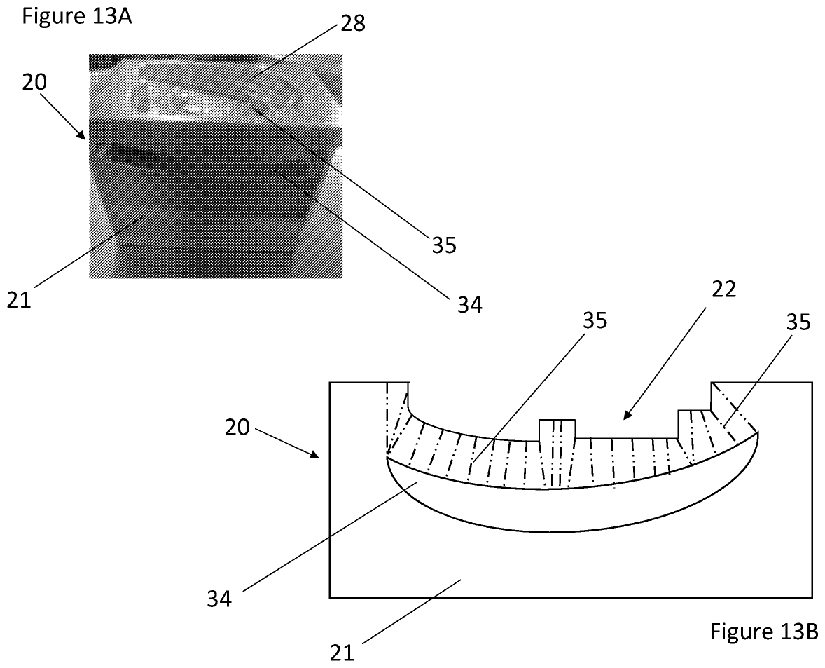

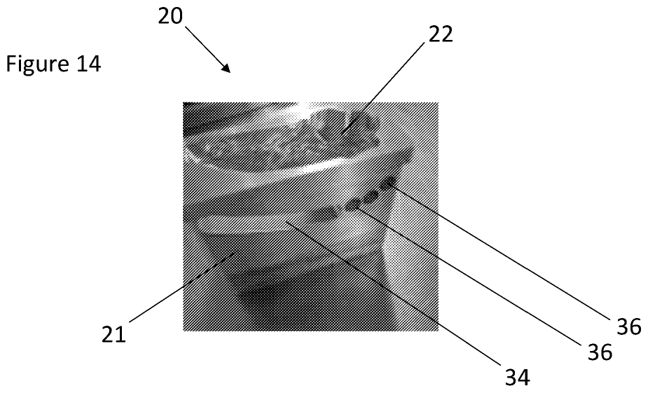

The base 21 of the die 20 comprises a primary air passage 34 to facilitate thermomoulding or thermo-forming of the food product 1 (see FIG. 13). In some embodiments, at least one supplementary air passage 36 is provided to increase suction to targeted portions of the moulding recess 22 (see FIG. 14). The or these supplementary air passages 36 facilitate use of more complex moulding recesses 22 to provide more detailed and thus more realistic looking fish and meat products. Some existing puree foods have been set into food moulds made from children's toys, such as those designed for plasticine or PlayDoh™; however, the end product is unrealistic and unappealing.

The die 20 is designed to be used with a lining material 24 laid out over the recess 22 of the die 20, illustrated in FIG. 10. The lining material 24 is flexible and pliable enough to take on a complex form of the recess 22. When the die 20 is inserted into a thermo-moulding machine, a vacuum is created that sucks air out of the recess 22 via the air passage 24 and the fluidly connected vacuum passages 35 to draw the lining material 24 tightly against a surface 28 of the moulding recess 22 in preparation for receiving the fish or meat paste 32, illustrated in the cross-sectional view of FIG. 11.

The thermo-moulding machine can be operated plug assisted, where complex forms or surface textures are required in the finished texture modified product 1. A plug assisted machine uses a punch (or similar moulded form) to aid or assist in the stretching of the lining material to take the form of the mould. The plug can be formed to provide co-operating fine detail to that of the mould recess 22. The plug is pressed into the lining 24, to allow the lining 24 to take the shape of the mould recess 22 with the assistance of the plug and a vacuum. The plug is then removed to allow for the introduction of the paste 32, which can then take on the complex form of the recess 22. This allows for very detailed textures in the finished product, for example, scales of a fish or chicken skin texture.

Although not illustrated, it is contemplated that the paste 32 can be injection moulded into the mould recess 22. Alternatively, the lining material 24 can be blow moulded to form individual moulds for receiving the paste wherein the paste is injected or inserted into the moulded lining material 24 before the lining material 24 is sealed to form a package and subsequently frozen.

The lining material 24 can be made from a number of suitable sterile food grade films, including high barrier laminated films, made from Polyvinyl chloride (PVC), Nylon and Polyethylene terephthalate (PETE or PET).

A thermo-former (or vacuum forming machine) relies on extracting vented air out a single hole or a row of horizontal holes along the base 21 of the die 20. Due to the complexity of the desired die in this invention, evenly spaced holes along the base 21 were found to produce an uneven vacuum across the geometry of the recess 22 where the film or lining material 24 was not fully conforming to the shape and form of the moulding recess 22. The addition of supplementary air passages 36 through the die 20 and die base 21 allow the vacuum across the surface of the recess 22 to be tailored, resulting in the lining material 24 and subsequently the paste 32 conforming more closely to the shape of the moulding recess 22.

The vacuum passages 35 and supplementary air passages 36 are formed at various angles through the die base 21, to draw the lining material 24 against the moulding recess 22 at a 90-degree angle to the surface 28 (illustrated in FIG. 13A and FIG. 13B).

In some embodiments a second upper mould is also inserted into the thermo-forming machine so that a two-sided moulded fish or meat product can be created, illustrated in the cross-sectional view of FIGS. 11B-11C. The paste 32 is injected (not illustrated) into the recess formed between the two sides of the mould after the vacuum is applied to draw the upper 25 and lower 24 lining materials against the recess surfaces.

Additional air passages 36 through the base 21 into the recess 22 will increase the vacuum and assist in pulling the lining 24, 25 into any tightly contoured forms of the recess 22. This is particularly useful where the recess 22 is deep or complex in form.

For ease of packaging, the lining material 24 can be selected to also be a packaging material for the finished texture modified food product 1. This has the added benefit of reducing head space (and trapped air) within the package product 26 thereby improving protection of the fish or meat product from freezer burn. This is of importance as texture modified fish and meat products are more susceptible to freezer burn than a natural frozen product due to the chemical changes in the cellular structure of the fish or meat product during processing. To this end, a second layer of lining material 25, of the same or a different material, can be placed over the recess 22 after the recess 22 has been filled. The upper lining material 25 and lower lining material 24 can then be sealed to one another to form a pouch or package 30 for a single serve 26 of the product 1, illustrated in FIGS. 7 and 8. The upper 25 and lower lining material 24 can be sealed together by heat forming a single-use seal, or formed to provide closing tabs 23a that can provide a re-usable seal.

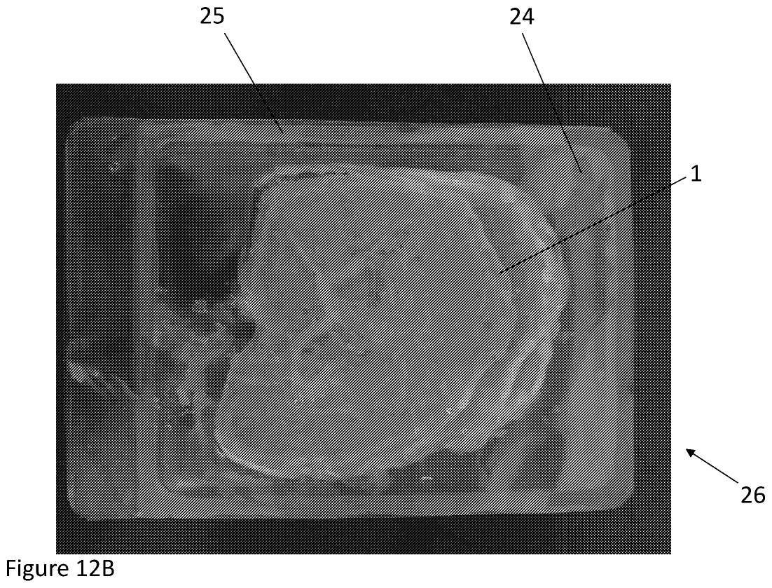

The texture modified food product 1 can also be formed and packaged in a multi-pack 27 as illustrated in FIG. 12A. The multi-pack 27 can have perforations 29 or be otherwise separable, to allow a single 26 or multi-serve 27 of the food product 1 to be selected and prepared for consumption. The remaining, unused serves of the multi-pack 27 can be returned to freezer storage or cold storage for use at a later time.

The finished packaged food product can be air evacuated prior to sealing the package 30. In some embodiments the package 30 is back flushed with carbon dioxide and nitrogen to remove suspended oxygen from the moulded fish or meat product 1.

Additionally, the sealed evacuated package can be pasteurised to increase usable shelf life of the packaged product. Pasteurising the sealed product significantly reduces the microbial count of the texture modified food product 1. In many countries, nominated vulnerable groups e.g. hospital patients, aged care residents etc. will have standards for “ready-to-eat” products, particularly proteins which are the highest risk products. Duration and temperature of the pasteurisation process can be tailored to meet the required national standards, as required.

In some embodiments, the sealed evacuated package 30 can be high pressure processed (HPP also referred to as Pascalisation). While effectively reducing the microbial count of the food and destroying pathogens, the HPP process has minimal effect on the colour, flavour or vitamin content in the protein-based food product, unlike traditional pasteurisation techniques, where the heat from the pasteurisation process can discolour some foods and alter flavour and nutrients therein.

HPP is effectively a cold pasteurization technique, where the sealed evacuated package 30 is exposed to a high level of hydrostatic pressure, up to 600 MPa, for a few seconds to a few minutes. The high level of pressure exerted by the water surrounding the sealed package effectively inactivates certain microorganisms and enzymes in food, without the application of heat.

The standard for killing bacteria in high protein foods is very high and some form of cooking process will always be required for these high protein foods to achieve the required safety standards.

In Victoria, Australia, the government has a food business classification system, in which the class 1 service sector encompasses food businesses that provide meals to patients in: hospitals, hospices, child services, vulnerable persons, meal delivery organisations, nursing services, and aged persons. The texture modified food products 1 described herein are manufactured to conform to these requirements under the Food Act 1984.

FANZA provides standards for ready to eat products in a class 1 (any nominated vulnerable group e.g. hospital patients, aged care residents). Pasteurisation will extend the product's shelf life under refrigeration.

The paste 32 can be deposited into the mould 20 in a chilled state. However, where the recess 22 is a complex form, warming the paste 32 prior to introducing the paste into the mould can assist in filling the mould recess and reducing voids and air bubbles in the finished food product 1. To speed up the setting time of the paste 32 the mould 20 can be chilled such that contact with the mould starts the paste 32 setting on contact.

The mould can be manufactured to provide one or more than one recess, shaped to conform to a generic serve of the fish or meat selected to form the paste. The shape of the desired product and size of thermo-former used will limit the available options for design of the die or mould.

Where the mould provides a plurality of shaped recesses 22, each of the plurality of shaped recesses being configured to set the fish or meat paste into a form of the generic serving of the fish or meat selected to form the paste. Each of the plurality of shaped recesses has an equal volume. The shaped recesses are sized for small portions between 90 g-120 g, and preferably about 100 g, as too much food can be off-putting or overwhelming to the consumer with dysphagia. The texture modified food product 1 is formed and set in the approximately 100 g portions, wherein additional texture modified vegetables can be added to modify the portions sizes between small and large meals. The home and community care (HACC) standards recommend cooked portions sizes of between 90 g-100 g for cooked protein. These standardised portions can easily be configured to cater for changes in appetite of the consumer and makes for a more realistic appearance of the finished texture modified meal.

After the sealed pouch is pasteurised, hot or cold, it is rapidly chilled such as in a blast chiller and then frozen. The frozen product facilitates storage, handling and plating of the texture modified food 1, prior to heating and serving. While heating of the finished food product is initially carried out immediately prior to serving and consumption of the product, as the fish or meat product retains its shape through the heating process, the fish or meat product can be reheated during a meal session as feeding times can be slow for these consumers and the product may cool faster than their rate of consumption. Not all texture modified food products will require heating and some fish and meats can be simply thawed and served, without heating eg. Tuna, scallops and prawns.

The finished package 30, once frozen, reduces contamination from food handling as the product stays in the finished package, provides for an increased shelf-life and facilitates ease of transport and distribution.

For some fish or meat, the paste 32 requires additives to help the paste retain or acquire the required consistency and flow characteristics. These additives may assist in the overall forming of the texture modified food product 1 and can also assist with product form retention during heating of the thawed food product 1.

Any required additives are introduced into the paste 32 prior to setting the paste in the die 20. As different fish and meats have different moisture levels, a small amount of vegetable fibre can assist with giving back structure to the paste 32 without changing the smoothness of the paste 32 required to meet the proposed international standard or changing the flavour profile of the paste 32. Gelatin and starch can also be used to add structure back to the paste 32.

For some fish and meat, a fibre content in the paste of between 1-5% is sufficient to achieve the required structure. Preferably about 3% of vegetable fibre is added to the paste 32. In practice, paste made from fish is more likely to require vegetable fibre than paste made from meat.

For some fish and meat Xanthan gum can be added to the paste 32, particularly for chicken and pork products.

The Xanthan gum can prevent some bleeding of liquid from the food product 1 while defrosting. The Xanthan gum helps the paste 32 retain moisture and thereby prevent the fish or meat product 1 from drying out. A Xanthan gum content of between 0.1-0.5% is sufficient to reduce bleeding of liquids. Preferably about 0.3% of Xanthan gum is added to the paste 32.

Agglomerated modified potato starch (AMPS) can also be added to the paste 32 to help assist the fish or meat product in retaining its shape when being heated for service; particularly for chicken and pork. Both AMPS and Xanthan gum give the paste 32 a mousse-like texture and inhibit the moulded food product 1 structure from losing its form when heated. An AMPS content of between 1.0-3.0% is sufficient to retain the products shape through a heating process. Preferably about 2.5% of AMPS is added to the paste 32.

The AMPS can be directly added to the paste 32 and will evenly distribute therethrough. Additional AMPS will naturally thicken the paste 32 and does not require the addition of heat to do so. The addition of AMPS until now has been avoided as thickening of the paste 32 would appear contrary to the process of producing the puree. However, through trial and experimentation it was found that the relevant standards can be met, and the fish or meat product can still retain sufficient structure to hold its shape and form, through a heating process.

During pasteurising the connective tissue (collagen) in these meats breaks-down into gelatine and will separate in the moulded pack, leaving the rest of the meat dry and grainy. The addition of AMPS and Xanthan Gum solves this problem. Fish has the same issue of breaking down connective tissue during pasteurisation as meat. However, fish also has a much higher moisture content so that when it is pureed it can become sloppy so adding vegetable fibre to the paste assists in giving back some structure to the paste 32.

The additives are selected from at least one of: Xanthan gum; modified potato starch; agglomerated modified potato starch (AMPS); natural vegetable fibre; bamboo fibre; flavourless starch; salt and pepper. However, a combination of additives including a ratio percentage of Xanthan gum (XG), agglomerated modified potato starch (AMPS) and a natural vegetable fibre (bamboo fibre) was found to provide the required consistency in the paste 32.

The texture modified food product 1 provides a nutrient rich food that can be eaten and digested by people suffering from dysphagia. Aside from retaining minerals and vitamins present in the fish or meat from which the paste is formed, the processing method described herein retains the natural colours and flavour profiles of the selected fish or meat.

Unlike more traditional pureeing processes, using a blender that would require a liquid component to puree the product, the paste 32 does not include a stock or additional cooking water, thus the nutrient levels are significantly higher than currently available puree products.

Minimal additives into the paste, prior to setting, allows the texture modified food product to be frozen, transported, defrosted and heated, while retaining the desired shape of the selected serving of fish or meat.

The individual, microwavable, portions allow for balancing and monitoring meals simply and in a convenient manner while also facilitating easy variation for loss or increase in appetite. It is contemplated that a facility can maintain a supply of multiple fish and meats, all in pre-portioned packs, such that a consumer can select any desired combination of protein and vegetable texture modified food products to form a meal. It is further contemplated that pre-assembled complete meals can be assembled and packaged and sold as convenience meals. For hospitals, and aged care facilities, this can bring a much-needed flexibility to their catering operation. All texture modified food products 1 are prepared to the predetermined standard and can be delivered and stored in bulk. With minimal work, individual plates of food can be made up to an individual's preference from the frozen food products 1, providing nutritious and varied modified texture meals.

The fish or meat product 1 is selectively heated prior to consumption, unless it is a fish or meat product to be served cold that merely requires thawing before consumption.

As the fish or meat product 1 can be sensitive to moisture loss when heated, the fish or meat product 1 should be covered when heated.

While the fish or meat product 1 can be steamed or microwaved, it is also configured to be passed through a banqueting system, or other heated trolley systems such as Berlodge™ Regethermic™ or Rational™ carts. These methods are suitable for high volume catering and are used in some hospitals and aged care facilities.

A typical banqueting system has a heating cycle of about 9-12 minutes at temperatures of about 120° Celcius. Banqueting systems are used to heat the fish or meat product 1 once arranged on a plate. The Banqueting system heats the plate and the texture modified food product together, and the hot plate continues to heat the tmf product after the plate is removed from the system. Due to the timing and temperatures used in a banqueting system the fish or meat product 1 will not change colour, flavour or form because of this process, thereby preserving the visually appealing colour, taste, shape and nutritional value of the packed tmf product 1 as supplied.

### Dressing a Texture Modified Food Product

To further create a visually appealing modified texture food product and better resemble the look and flavour of a non-tmf fish or meat a dressing or coating 33 can be added to the tmf product. For example, a chicken or veal product can be coated to resemble a schnitzel or a crumbed fish 9 (illustrated in FIG. 17).

The coating 33 can be made from potatoes or bread.

The coating 33 made from potatoes starts with a raw potato which is thinly sliced or shredded or grated. The comminuted potato pieces are then fried until crisp and left to cool. During the cooling period, excess oil is drained from the fried potato pieces.

As an alternative, commercially available potato chips (crisps) can be used to speed up the preparation time. The fried potato pieces can be salted to enhance natural flavour.

The salted or unsalted fried potato pieces are then broken down into a fine powder. This can be achieved using a bowl cutter, a food processor, a shearing mill or a mill stone. The resulting fine powder has a sheen, making it appear damp, from the oil content therein.

The potato powder can be additionally flavoured, for example, by adding dry turmeric powder and dried sweet paprika powder, to about 0.5% weight. These spices are merely examples and any number of spices and herbs can be added to the potato powder to achieve a range of coatings 33 providing different flavour profiles. An acid can also be introduced into the coating to produce a salt and vinegar flavour profile.

The finished coating 33 can be stored in an air-tight container. The coating enhances both appearance and flavour; as the coating provides a fried chip taste.

The coating 33 made from bread starts with thinly sliced or shredded bread. The bread may then be cooked in either an oven or a deep fryer (and the like) to achieve the desired coating colour, flavour profile and moisture content (ie. cooked to crisp). Coating mixture is then removed from the cooking appliance to cool. During the cooling period, excess oil is drained or spun from the fried bread pieces.

The salted or unsalted fried bread pieces are then broken down into a fine powder. This can be achieved using a bowl cutter, a food processor, a shearing mill or a mill stone. The resulting fine powder has a sheen, making it appear damp, from the oil content therein. If the coating mixture clumps, a puffed rice powder may be added to aid separation and give a loamy texture.

The coating mixture can be additionally flavoured, for example, by adding dry turmeric powder and dried sweet paprika powder, to about 0.5% weight. These spices are merely examples, and any number of spices and herbs can be added to the coating mixture to achieve a range of coatings 33 providing different flavour profiles. An acid can also be introduced into the coating to produce a salt and vinegar flavour profile.

The coating 33 can also be made from other starches that are not hydrophobic, for example a rice starch (illustrated in the fish product 8 of FIG. 17, where a bread coating and a rice coating were applied simultaneously, the rice based coating for colour and adherence and the bread based coating for a darker colour and for an appropriate flavour profile, this can be contrasted to the chips 10 of FIG. 17 that are coated in the potato based coating and have not only a lighter colour appearance but also a different flavour profile).

As with the potato-based coatings, any combination of herbs and spices can be added to the coating 33 for different flavours and appearances.

To apply the coating 33, the fish or meat product is cut or formed into a desired end shape; for example, a drum stick or schnitzel. The texture modified fish or meat products can then be allowed to thaw before coating.

A fine spray or mist of water or salt water can be applied to the surface of the texture modified food product to soften the surface and facilitate better adhesion of the coating 33. The tmf product can be dusted, or rolled in the coating 33, as desired.

The coated tmf product is left for about an hour, to allow the water mist and exterior surface water on the tmf product to be absorbed into the coating, softening it, and ensuring that the required tmf standards are met by the coated tmf product 1.

The coated tmf product is then heated ready for service. At which time the heating of the product adheres the coating 33 to the food product 1 and provides additional colour, flavour and texture to the texture modified food product 1 when served.

It will be appreciated by persons skilled in the art that numerous variations and modifications may be made to the above-described embodiments, without departing from the scope of the following claims. The present embodiments are, therefore, to be considered in all respects as illustrative of the scope of protection, and not restrictively.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the example methods and materials are described herein.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### LEGEND

| No. | |
|---|---|
| 1 | Texture modified food product |
| 2 | Closing tab |
| 3 | |
| 4 | Flesh texture |
| 5 | Seam |
| 6 | Texture modified Chicken breast |
| 7 | Casserole meal |
| 8 | Texture modified carrot product |
| 9 | Texture modified fish product |
| 10 | Texture modified potato |
| 11 | Texture modified broccoli |
| 12 | Stir-fry meal |
| 13 | Texture modified beef slices |
| 14 | Texture modified pumpkin |
| | product |
| 15 | Texture modified beef steak |
| 16 | Texture modified pea product |
| 17 | Roast meal |
| 18 | Prawn |
| 19 | Gravy (viscosity modifier) |
| 20 | Die |
| 21 | Base |
| 22 | Moulding recess |
| 23 | Die top surface |
| 23a | Tabs |
| 24 | Lower liner layer |
| 25 | Upper liner layer |
| 26 | Individually packaged |
| | product |
| 27 | Multi-pack product |
| | product |
| 28 | Surface of recess |
| 29 | Perforation lines |
| 30 | Packaging |
| 31 | Second surface of recess |
| 32 | Texture modified food paste |
| 33 | Coating |
| 34 | Primary air passage |
| 35 | Vacuum passages |
| 36 | Supplementary air passages |

1. A method of preparing a texture modified food product for consumption by a dysphagic consumer, comprising the steps:
a) providing a cooked fish or meat;
b) comminuting the cooked fish or meat to form a paste; and
c) forming the paste into the texture modified food product shaped and textured to a generic serve of the fish or meat selected to form the paste.

2. The method of claim 1, wherein step (b) includes comminuting without any added water or liquid stock.

3. The method of claim 1, wherein the step of cooking the raw fish or meat involves plunging the fish or meat into boiling water for a predetermined time period.

4. The method of claim 1, wherein the method further comprises a step of adding air into the paste to form a mousse-like consistency.

5. The method of claim 1, wherein step (b) includes aerating the cooked fish or meat during the comminution step and forming the paste with a mousse-like consistency.

6. The method of claim 1, wherein the step of comminuting the partially cooked fish or meat is performed with a shear-blade cutter or a bowl cutter.

7. The method of claim 6, additionally continuing the step of comminuting the partially cooked fish or meat until the paste takes on a mousse-like consistency.

8. The method of claim 1, further comprising the step of assessing the consistency of the paste prior to setting the paste in the mould.

9. The method of claim 8, wherein the step of assessing the consistency of the paste additionally involves a step of adjusting the paste to increase the viscosity of the paste to meet a predetermined standard.

10. The method of claim 9, wherein the step of adjusting the paste involves repeating the comminuting step.

11. The method of claim 1, further comprising the step of introducing an additive into the paste prior to forming the paste.

12. (canceled)

13. The method of claim 1, wherein forming the paste involves setting the paste in a mould.

14. (canceled)

15. (canceled)

16. (canceled)

17. The method of claim 13, maintaining the mould at a temperature below 1 degree Celsius to set the texture modified food product.

18. The method of claim 13, setting the paste in the mould, wherein the mould provides a recess shaped and/or textured to form the paste to the generic serve of the fish or meat selected to form the paste.

19. (canceled)

20. (canceled)

21. The method of claim 13, further comprising a step of lining the mould with a first layer of packaging material prior to introducing the paste therein.

22. (canceled)

23. (canceled)

24. The method of claim 21, further comprising the step of disposing a second layer of packaging material over the mould after the paste has been received therein and fusing the second layer with the first layer of packaging material thereby forming a sealed pouch around the moulded texture modified food product.

25. The method of claim 24, further comprising the step of air evacuating the sealed pouch prior to sealing.

26. The method of claim 24, further comprising the step of back-flushing the pouch with carbon dioxide and nitrogen to remove suspended oxygen from the moulded texture modified food product prior to sealing the pouch.

27. The method of claim 24, further comprising the step of hot pasteurising or cold pasteurising the sealed pouch to increase usable shelf life of the packaged product.

28. (canceled)

29. (canceled)

30. (canceled)

31. A texture modified food product for consumption by a dysphagic consumer, comprising;
a paste formed from a fish or meat, the paste retaining the flavour of the fish or meat selected; and
an additive selected from a group comprising: Xanthan gum; Guar gum; modified potato starch; agglomerated modified potato starch (AMPS); natural vegetable fibre; bamboo fibre; flavourless starch; salt and pepper,
wherein the texture modified food product is shaped and textured to a generic serve of the fish or meat selected to form the paste.

32. (canceled)

33. (canceled)
